(19) United States
(12) Patent Application Publication
(10) Pub. No.: US 2015/0347646 A1
(43) Pub. Date: Dec. 3, 2015

(54) NUMERICAL APPROACH FOR COMPUTING FLUID FLOW VARIABLES FOR THREE-WAY FLOW COMPONENTS IN 1D FLUID FLOW NETWORKS

(71) Applicant: AIRBUS GROUP INDIA PRIVATE LIMITED, Bangalore (IN)

(72) Inventors: Prashant ARORA, Bangalore (IN); Vikram MANGAT, Bangalore (IN)

(21) Appl. No.: 14/724,889

(22) Filed: May 29, 2015

(30) Foreign Application Priority Data
Jun. 3, 2014 (IN) 2716/CHE/2014

(51) Int. Cl. G06F 17/50; F17D 1/20; G06F 17/10; F17D 3/01

(52) U.S. Cl. CPC G06F 17/5009; F17D 3/01; F17D 1/20; G06F 17/10

(57) ABSTRACT

A numerical approach for computing fluid flow variables for three-way components in one-dimensional (1D) fluid flow networks is disclosed. In one embodiment, a first flow configuration type of a three-way flow component is determined using geometric properties and fluid flow characteristics of the three-way flow component. Further, a first flow ratio for the three-way flow component is computed using the first flow configuration type. Furthermore, fluid flow loss coefficients for the three-way flow component are obtained based on the geometric properties and the first flow ratio. Also, equivalent pipe loss coefficients for each pipe in the three-way flow component are computed from normalization of the obtained fluid flow loss coefficients. Moreover, the fluid flow variables are numerically solved for using the obtained equivalent pipe loss coefficients, the geometric properties and the fluid flow characteristics of the three-way flow component.

### RELATED APPLICATIONS

Benefit is claimed under 35 U.S.C. 119(a)-(d) to Foreign application Serial No. 2716/CHE/2014 filed in India entitled “NUMERICAL APPROACH FOR COMPUTING FLUID FLOW VARIABLES FOR THREE-WAY FLOW COMPONENTS IN 1D FLUID FLOW NETWORKS”, filed on Jun. 3, 2014, by AIRBUS GROUP INDIA PRIVATE LIMITED, which is herein incorporated in its entirety by reference for all purposes.

### TECHNICAL FIELD

Embodiments of the present subject matter generally relate to three-way flow components in one-dimensional (1D) fluid flow networks, and more particularly, to a numerical approach for computing fluid flow variables for the three-way flow components in the 1D fluid flow networks.

### BACKGROUND

Typically, fluid flow modeling of three-way flow components, such as a T-junction, a Y-junction and the like, in one-dimensional (1D) fluid flow networks is performed using existing tools. These existing tools use a database to perform the fluid flow modeling for evaluating fluid flow variables. The database may include flow behaviors of the three-way flow components with defined geometric properties and/or theoretical and experimental data of fluid flow loss coefficients for modeling the three-way flow components with defined geometric properties.

However, fluid flow loss coefficients data for three-way flow components with undefined geometric properties may not be available in the database. For example, a through pipe having different diameter on either side. Also, flow behaviors of the three-way flow components, in the database, cannot be tweaked. Therefore, the fluid flow modeling of the three-way flow components with undefined geometric properties using existing fluid flow loss coefficients data may lead to unrealistic results.

### SUMMARY

A numerical approach for computing fluid flow variables for three-way flow components in one-dimensional (1D) fluid flow networks is disclosed. According to one aspect of the present subject matter, a first flow configuration type of a three-way flow component is determined using geometric properties and fluid flow characteristics of the three-way flow component. Further, a first flow ratio for the three-way flow component is computed using the first flow configuration type. Furthermore, fluid flow loss coefficients for the three-way flow component are obtained based on the geometric properties and the first flow ratio. Also, equivalent pipe loss coefficients for each pipe in the three-way flow component are computed from normalization of the obtained fluid flow loss coefficients. Moreover, fluid flow variables are numerically solved for using the obtained equivalent pipe loss coefficients, the geometric properties and the fluid flow characteristics of the three-way flow component.

According to another aspect of the present subject matter, a system includes a processor and a memory coupled to the processor. Further, the memory includes a computational fluid dynamics (CFD) tool. In one embodiment, the CFD tool includes instructions to perform the method described above.

According to yet another aspect of the present subject matter, a non-transitory computer-readable storage medium for computing fluid flow variables for the three-way flow components in the 1D fluid flow networks, having instructions that, when executed by a computing device causes the computing device to perform the method described above.

The system and method disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 is a flow diagram illustrating an example method for computing fluid flow variables for a three-way flow component in a one-dimensional (1D) fluid flow network, according to one embodiment;

FIG. 2 is another flow diagram illustrating a detailed method for computing the fluid flow variables for the three-way flow component in the 1D fluid flow network, according to one embodiment;

FIGS. 3A and 3B are example schematics of 1D fluid flow networks illustrating a method of performing flow reversal on three-way flow components, according to one embodiment; and

FIG. 4 illustrates a system including a fluid flow variables computation module for computing fluid flow variables for three-way flow components in 1D fluid flow networks, using the processes described with reference to FIGS. 1 to 3, according to one embodiment.

The drawings described herein are for illustration purposes only and are not intended to limit the scope of the present disclosure in any way.

### DETAILED DESCRIPTION

A numerical approach for computing fluid flow variables for three-way flow components in one-dimensional (1D) fluid flow networks is disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

Today, fluid flow modeling of three-way flow components, such as a T-junction, a Y-junction and the like, with defined geometric properties is performed using existing tools. The existing tools use a database which includes theoretical and experimental data of fluid flow loss coefficients for modeling the three-way flow components with the defined geometric properties. Also, flow behaviors of the three-way flow components, in the database, cannot be tweaked.

The present technique enables modeling three-way flow components with undefined geometric properties by including certain geometric properties of the three-way flow components in numerical calculations. Further, changes in flow directions and the consequent changes in flow configuration type of the three-way flow components are also considered in the numerical calculations to obtain realistic results.

In one embodiment, a flow configuration type of a three-way flow component is determined using geometric properties and fluid flow characteristics of the three-way flow component. Further, a flow ratio for the three-way flow component is computed using the flow configuration type. Furthermore, fluid flow loss coefficients are computed for the three-way flow component based on the geometric properties and the flow ratio. In addition, equivalent pipe loss coefficients for each pipe in the three-way flow component are computed using the obtained fluid flow loss coefficients. Also, fluid flow variables are numerically solved for using the obtained equivalent pipe loss coefficients, the geometric properties and the fluid flow characteristics of the three-way flow component.

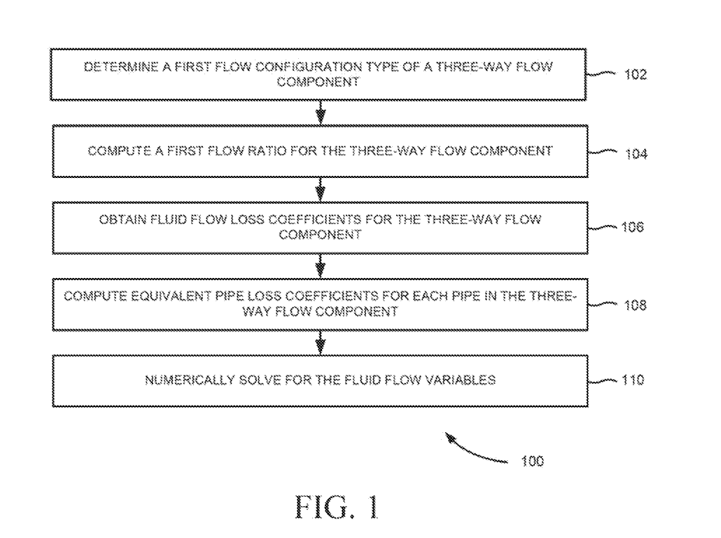

FIG. 1 illustrates a flow diagram 100 of an example method for computing fluid flow variables for a three-way flow component in a 1D fluid flow network, according to one embodiment. At step 102, a first flow configuration type of the three-way flow component is determined using geometric properties and fluid flow characteristics of the three-way flow component. Exemplary three-way flow component includes a T-junction, a Y-junction and the like. Exemplary geometric properties include a branch pipe diameter, a through pipe diameter, a branch angle, a through pipe cross-sectional area, a branch pipe cross-sectional area, an area ratio, and the like. Exemplary fluid flow characteristics include a fluid density, a mass flow rate, a fluid pressure, and the like.

At step 104, a first flow ratio for the three-way flow component is computed using the first flow configuration type. At step 106, fluid flow loss coefficients for the three-way flow component are obtained based on the geometric properties and the first flow ratio. In one embodiment, it is determined whether the first flow ratio is an extreme flow ratio. If it is determined that the first flow ratio is not an extreme flow ratio, then the fluid flow loss coefficients for the three-way flow component are obtained based on the geometric properties and the first flow ratio.

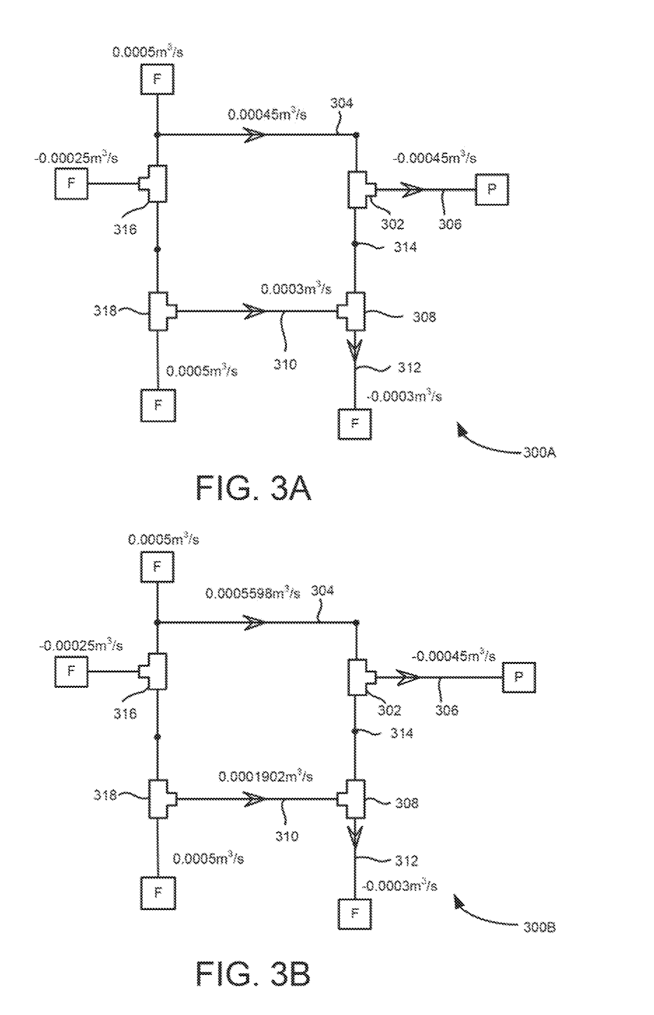

Further in this embodiment, if it is determined that the first flow ratio is an extreme flow ratio, then flow reversal is performed on a pipe with substantially no flow in the three-way flow component. This is explained in detail with reference to FIGS. 3A and 3B. Further, a second flow configuration type of the three-way flow component is determined upon performing the flow reversal. Furthermore, a second flow ratio for the three-way flow component is computed using the second flow configuration type. For example, it is checked whether the second flow configuration type is substantially similar to the first flow configuration type. If it is determined that the second flow configuration type is substantially similar to the first flow configuration type, then the steps of performing the flow reversal, determining the second flow configuration type, and checking are repeated for a predetermined number of times. Further, the fluid flow loss coefficients for the three-way flow component are computed using the first flow ratio after the flow reversal on the pipe is performed for the predetermined number of times.

In addition in this embodiment, if it is determined that the second flow configuration type is not substantially similar to the first flow configuration type, then the second flow ratio is computed using the second flow configuration type. Also, the fluid flow loss coefficients are obtained for the three-way flow component based on the geometric properties and the second flow ratio.

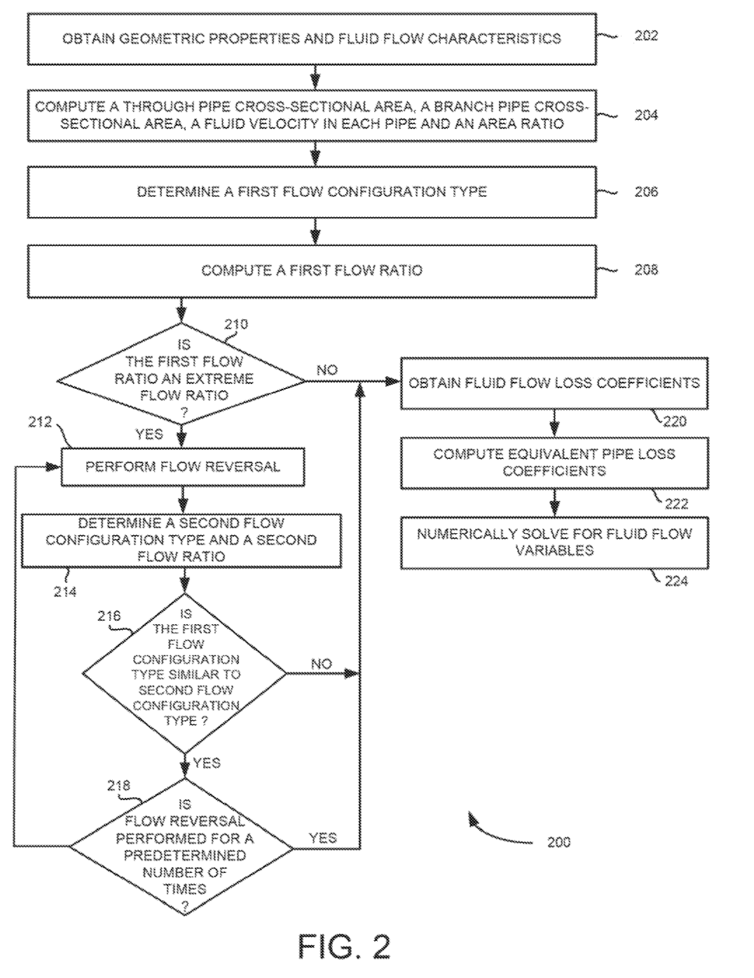

At step 108, equivalent pipe loss coefficients are computed for each pipe in the three-way flow component from normalization of the obtained fluid flow loss coefficients. At step 110, the fluid flow variables are numerically solved for using the obtained equivalent pipe loss coefficients, the geometric properties and the fluid flow characteristics of the three-way flow component. Exemplary fluid flow variables include a fluid pressure, a mass flow, a temperature, a fluid velocity and the like. This is explained in detail with reference to FIG. 2.

Referring now to FIG. 2, which illustrates another flow diagram 200 of a detailed method for computing fluid flow variables for a three-way flow component in a 1D fluid flow network, according to one embodiment. At step 202, geometric properties and fluid flow characteristics of the three-way flow component are obtained. Exemplary geometric properties include a branch pipe diameter, a through pipe diameter, a branch angle, and the like. Exemplary fluid flow characteristics include a fluid density, a mass flow rate, a fluid pressure, and the like. At step 204, a through pipe cross-sectional area, a branch pipe cross-sectional area, an area ratio and a fluid velocity in each pipe are computed using the geometric properties and the fluid flow characteristics.

At step 206, a first flow configuration type of the three-way flow component is determined using the geometric properties and the fluid flow characteristics of the three-way flow component. For example, a three-way flow component may exhibit a splitting flow configuration type or a pooling flow configuration type. The splitting flow configuration type is exhibited when an inflow of fluid occurs from one pipe, the fluid divides at a junction and outflow of the fluid occurs from other two pipes in the three-way flow component. The pooling flow configuration type is exhibited when an inflow of the fluid occurs from two pipes and the combined outflow of the fluid occurs from the other pipe in the three-way flow component.

In one embodiment, the flow configuration type of the three-way flow component is determined based on magnitude and direction of the fluid flow in each pipe in the three-way flow component. The direction of fluid flow in each pipe is indicated by a sign (for example, positive sign indicates outflow and negative sign indicates inflow) associated with a value of mass flow rate in each pipe. For example, if the mass flow rate is positive in pipe 1, positive in pipe 2 and negative in pipe 3, then the flow configuration type of the three-way flow component is a splitting flow configuration type. In this example, the mass flow rate in each pipe in the three-way flow component is computed using equations:

$$\begin{matrix}{\dot{m}}_{1} = \frac{2 ρ {A}_{1}^{2}}{\vert {\dot{m}}_{1} \vert {k}_{1}} ( {P}_{4} - {P}_{1} ) & ( 2 ) \\ {\dot{m}}_{2} = \frac{2 ρ {A}_{2}^{2}}{\vert {\dot{m}}_{2} \vert {k}_{2}} ( {P}_{4} - {P}_{2} ) & ( 3 ) \\ {\dot{m}}_{3} = \frac{2 ρ {A}_{3}^{2}}{\vert {\dot{m}}_{3} \vert {k}_{3}} ( {P}_{4} - {P}_{3} ) & ( 4 )\end{matrix}$$

wherein,

m₁, m₂ and m₃ are mass flow rates in pipe 1, pipe 2 and pipe 3, respectively;

ρ is a fluid density which is assumed to be constant for incompressible flows;

k₁, k₂ and k₃ are fluid flow loss coefficients associated with pipe 1, pipe 2 and pipe 3, respectively;

A₁, A₂ and A₃ are areas of the pipe 1, pipe 2 and pipe 3, respectively; and

P₁, P₂, P₃ and P₄ are pressure at node 1, node 2, node 3 and node 4, respectively, wherein node 1, node 2 and node 3 are associated with pipe 1, pipe 2 and pipe 3, respectively, and the node 4 is a node connecting the pipe 1, pipe 2 and pipe 3.

Introducing coefficients C₁, C₂ and C₃, wherein:

$${C}_{1} = \frac{2 ρ {A}_{1}^{2}}{\vert {\dot{m}}_{1} \vert {k}_{1}}$$

$${C}_{2} = \frac{2 ρ {A}_{2}^{2}}{\vert {\dot{m}}_{2} \vert {k}_{2}}$$

$${C}_{3} = \frac{2 ρ {A}_{3}^{2}}{\vert {\dot{m}}_{3} \vert {k}_{3}}$$

Now, using the coefficients C₁, C₂ and C₃ in the equations 2, 3 and 4, m₁, m₂, and m₃ are obtained using:

\dot{m}₁=C₁(P₄−P₁) (5)

\dot{m}₂=C₂(P₄−P₂) (6)

\dot{m}₃=C₃(P₄−P₃) (7)

Applying conservation of mass to the equations 5, 6 and 7, would result in:

\dot{m}₁+\dot{m}₂+\dot{m}₃=0

Therefore,

C₁(P₄−P₁)+C₂(P₄−P₂)+C₃(P₄−P₃)=0 (8)

Rearranging equation 8, P₄ can be obtained as:

$${P}_{4} ( {C}_{1} + {C}_{2} + {C}_{3} ) = {C}_{1} ( {P}_{1} ) + {C}_{2} ( {P}_{2} ) + {C}_{3} ( {P}_{3} ) \\ {P}_{4} = \frac{{C}_{1} ( {P}_{1} ) + {C}_{2} ( {P}_{2} ) + {C}_{3} ( {P}_{3} )}{( {C}_{1} + {C}_{2} + {C}_{3} )} \qquad ( 9 )$$

Using the equation 9, in equation 5, m₁ is obtained as:

$${\hat{m}}_{1} = - {C}_{1} ( {P}_{1} ) + {C}_{1} ( \frac{{C}_{1} ( {P}_{1} ) + {C}_{2} ( {P}_{2} ) + {C}_{3} ( {P}_{3} )}{( {C}_{1} + {C}_{2} + {C}_{3} )} ) \\ {\dot{m}}_{1} = [ - \frac{{C}_{1} ( {C}_{2} + {C}_{3} )}{( {C}_{1} + {C}_{2} + {C}_{3} )} ] ( {P}_{1} ) + \frac{{C}_{1} {C}_{2}}{( {C}_{1} + {C}_{2} + {C}_{3} )} ] ( {P}_{2} ) + \frac{{C}_{1} {C}_{3}}{( {C}_{1} + {C}_{2} + {C}_{3} )} ] ( {P}_{3} ) ] \qquad ( 10 )$$

Similarly, m₂ and m₃ are obtained as:

$$\begin{matrix}{\dot{m}}_{2} = [ \frac{{C}_{1} {C}_{2}}{( {C}_{1} + {C}_{2} + {C}_{3} )} ] ( {P}_{1} ) - \frac{{C}_{2} ( {C}_{1} + {C}_{3} )}{( {C}_{1} + {C}_{2} + {C}_{3} )} ] ( {P}_{2} ) + \frac{{C}_{2} {C}_{3}}{( {C}_{1} + {C}_{2} + {C}_{3} )} ] ( {P}_{3} ) ] & ( 11 ) \\ {\dot{m}}_{3} = [ \frac{{C}_{1} {C}_{3}}{( {C}_{1} + {C}_{2} + {C}_{3} )} ] ( {P}_{1} ) + \frac{{C}_{2} {C}_{3}}{( {C}_{1} + {C}_{2} + {C}_{3} )} ] ( {P}_{2} ) - \frac{{C}_{3} ( {C}_{1} + {C}_{2} )}{( {C}_{1} + {C}_{2} + {C}_{3} )} ] ( {P}_{3} ) & ( 12 )\end{matrix}$$

At step 208, a first flow ratio of the three-way flow component is computed using the first flow configuration type. For example, a flow ratio is a ratio of mass flow rates between inflow and outflow of fluid which is computed based on the flow configuration type of the three-way flow component. At step 210, it is determined whether the first flow ratio is an extreme flow ratio. An extreme flow ratio is obtained when there is substantially no flow in one of the pipes in the three-way flow component. If it is determined that the first flow ratio is not an extreme flow ratio, then, at step 220, fluid flow loss coefficients for the three-way flow component is obtained based on the geometric properties and the first flow ratio.

If it is determined that the first flow ratio is an extreme flow ratio, then, at step 212, flow reversal is performed on a pipe with substantially no flow in the three-way flow component. This is explained in detail with reference to FIGS. 3A and 3B. At step 214, a second flow configuration type and a second flow ratio are computed upon performing the flow reversal.

At step 216, it is determined whether the second flow configuration type is substantially similar to the first flow configuration type. If it is determined that the second flow configuration type is not substantially similar to the first flow configuration type, then at step 220, fluid flow loss coefficients are obtained based on the geometric properties and the second flow ratio. If it is determined that the second flow configuration type is substantially similar to the first flow configuration type, then at step 218, it is determined whether flow reversal is performed for a predetermined number of times on the three-way flow component. If it is determined that the flow reversal is not performed for the predetermined number of times on the three-way flow component, then, the process steps are repeated from the step 212.

If it is determined that the flow reversal is performed for the predetermined number of times on the three-way flow component, then, at step 220, fluid flow loss coefficients for the three-way flow component is obtained based on the geometric properties and the first flow ratio. In one embodiment, the fluid flow loss coefficients are obtained from an existing database using the branch angle, the area ratio and the computed flow ratio. The existing database may include theoretical and experimental data of fluid flow loss coefficients for modeling the three-way flow components. In one example, if the fluid flow loss coefficients are not available in the existing database, interpolation or curve/surface fitting techniques are used to obtain the fluid flow loss coefficients.

At step 222, equivalent pipe loss coefficients for each pipe in the three-way flow component are computed from normalization of the obtained fluid flow loss coefficients. In one exemplary implementation, the equivalent pipe loss coefficients can be computed as follow:

The fluid flow loss coefficient obtained from the existing database may be defined as:

$${K}_{T branch} = [ Head Loss ] \frac{{V}_{combined}^{2}}{2 g} \qquad ( 13 )$$

wherein,

K_{Tbranch} is the fluid flow loss coefficient associated with a pipe;

Head loss is the head loss through the branch pipe;

V_{combined} is mean velocity of fluid flow in a pipe with combined flow; and

g is acceleration due to gravity.

Further, a pipe loss coefficient for a pipe in the three-way flow component is defined as:

$${K}_{pipe} = [ Head Loss ] \frac{{V}_{pipe}^{2}}{2 g} \qquad ( 14 )$$

wherein,

Kₚᵢₚₑ is the pipe loss coefficient associated with a pipe; and

Vₚᵢₚₑ is the mean velocity of fluid flow in the pipe.

Combining the equations 13 and 14, Kₚᵢₚₑ is obtained as:

$${K}_{pipe} = [ {K}_{T branch} ] \frac{{V}_{combined}^{2}}{{V}_{pipe}^{2}} \qquad ( 15 )$$

In this embodiment, two values of fluid flow loss coefficients are obtained from the existing database. Each of the fluid flow loss coefficient values is associated with a direction of fluid flow, that is, either flowing into or out of a pipe with combined flow. However, for normalization, the two values of fluid flow loss coefficients are associated with the pipes other than the pipe with combined flow. Therefore, the equivalent pipe loss coefficients for each pipe in the three-way flow component can be defined as:

$$\begin{matrix}{K}_{pipe 1} = relative zero & ( 16 ) \\ {K}_{pipe 2} = [ {K}_{1 - 2} ] \frac{{V}_{combined}^{2}}{{V}_{pipe 2}^{2}} & ( 17 ) \\ {K}_{pipe 3} = [ {K}_{1 - 3} ] \frac{{V}_{combined}^{2}}{{V}_{pipe 2}^{2}} & ( 18 )\end{matrix}$$

wherein,

pipe 1 is considered as the pipe with combined flow;

Kₚᵢₚₑ₁, Kₚᵢₚₑ₂ and Kₚᵢₚₑ₃ are equivalent pipe loss coefficients associated with pipe 1, pipe 2 and pipe 3, respectively; and

K₁₋₂ and K₁₋₃ are calculated based on the direction of fluid flow from node 1 to node 2 and node 1 to node 3, respectively, using the equation 15.

At step 224, fluid flow variables are numerically solved for using the obtained equivalent pipe loss coefficients, the geometric properties and the fluid flow characteristics of the three-way flow component.

Consider an example wherein the values of P₁, m₂, m₃, V₁, V₂, V₃ and V_{combined} are given. The values of m₁, P₂ and P₃ are computed as follows:

P₁=1.013×10E5 N/m²

\dot{m}₂=−0.5×1000=−500 kg/s

\dot{m}₃=−0.5×1000=−500 kg/s

V₁=10.218 m/s

V₂=2.546 m/s

V₃=2.546 m/s

V_{combined}=V₁

wherein,

V₁, V₂ and V₃ are the mean velocities of fluid flow in pipe 1, pipe 2 and pipe 3, respectively.

Obtaining the fluid flow loss coefficients from the existing database and transforming the fluid flow loss coefficients into equivalent pipe loss coefficients using the equations 16, 17 and 18, Kₚᵢₚₑ₁, Kₚᵢₚₑ₂ and Kₚᵢₚₑ₃ are obtained as:

$$\begin{matrix}{K}_{pipe 1} = relative zero = 1 e - 05 & \\ {K}_{pipe 2} = [ {K}_{1 - 2} ] \frac{{V}_{combined}^{2}}{{V}_{pipe 2}^{2}} = 17.362 & \\ {K}_{pipe 3} = [ {K}_{1 - 3} ] \frac{{V}_{combined}^{2}}{{V}_{pipe 2}^{2}} = 17.362 & \end{matrix}$$

wherein,

1e-05 is equivalent to zero.

Further, the coefficient C1, C2 and C3 are obtained as:

$${C}_{1} = \frac{2 ρ {A}_{1}^{2}}{\vert {\dot{m}}_{1} \vert {k}_{1}} = 19156.29$$

$${C}_{2} = \frac{2 ρ {A}_{2}^{2}}{\vert {\dot{m}}_{2} \vert {k}_{2}} = 0.008882$$

$${C}_{3} = \frac{2 ρ {A}_{3}^{2}}{\vert {\dot{m}}_{3} \vert {k}_{3}} = 0.008882$$

Furthermore, using the equations 10, 11 and 12, m₁, m₂ and m₃ are obtained as:

\dot{m}₁=[−0.01776](P₁)+[0.008882](P₂)+[0.008882](P₃) (19)

\dot{m}₂=[0.008882](P₁)+[−0.008882](P₂)+[4.12E-09](P₃) (20)

\dot{m}₃=[0.008882](P₁)+[4.12E-09](P₂)+[−0.008882](P₃) (21)

In addition, applying conservation of mass on the three-way flow component, results in:

\dot{m}₁+\dot{m}₂+\dot{m}₃=0 (22)

Using the values of m₂ and m₃ in the equation 22, m₁ is obtain as:

\dot{m}₁=1000 kg/s

Further, using the values of m₁, m₂, m₃ and P₁ in equations 19, 20 and 21, P₂ and P₃ are obtained as:

P₂=0.45×10E5 N/m2

P₃=0.45×10E5 N/m2

Referring now to FIGS. 3A and 3B, which are exemplary schematics of 1D fluid flow networks 300A and 300B, respectively, illustrating a method of performing flow reversal on three-way flow components, according to one embodiment. As shown in FIGS. 3A and 3B, the 1D fluid flow networks 300A and 300B include three-way flow components 302, 308, 316 and 318. Further as shown in FIGS. 3A and 3B, pipe 304 is an inlet pipe connected to the three-way flow component 302 and pipe 310 is an inlet pipe connected to the three-way flow component 308. Furthermore as shown in FIGS. 3A and 3B, pipe 314 connects the three-way flow components 302 and 308.

As shown in FIG. 3A, the inlet pipe 304 of the three-way flow component 302 has a mass flow rate of 0.00045 m³/s. Further as shown in FIG. 3A, the outlet pipe 306 of the three-way flow component 302 has a mass flow rate of −0.00045 m³/s. Furthermore as shown in FIG. 3A, the inlet pipe 310 of the three-way flow component 308 has a mass flow rate of 0.0003 m³/s. In addition as shown in FIG. 3A, the outlet pipe 312 of the three-way flow component 308 has a mass flow rate of −0.0003 m³/s. Therefore, there is substantially no flow in the pipe 314. This indicates an extreme flow ratio for the three-way flow components 302 and 308.

In one embodiment, flow reversal is performed on the three-way flow components 302 and 308 with the extreme flow ratio. Upon performing the flow reversal, as shown in FIG. 3B, the inlet pipe 304 of the three-way flow component 302 has a mass flow rate of 0.0005598 m³/s. Further as shown in FIG. 3B, the outlet pipe 306 of the three-way flow component 302 has a mass flow rate of −0.00045 m³/s. Furthermore as shown in FIG. 3B, the inlet pipe 310 of the three-way flow component 308 has a mass flow rate of 0.0001902 m³/s. In addition as shown in FIG. 3B, the outlet pipe 312 of the three-way flow component 308 has a mass flow rate of −0.0003 m³/s. Therefore, a new flow configuration type is obtained for the three-way flow components 302 and 308 upon performing flow reversal.

In one example, upon performing the flow reversal, if a new flow configuration type is not obtained for the three-way flow components 302 and 308, then the flow reversal is performed for a predetermined number of times. For example, the number of times the flow reversal is performed is limited to the predetermined number of times to avoid divergence. Divergence occurs when the numerical calculations of the fluid flow variables, using the method described with reference to FIGS. 1 and 2, results in unrealistic solutions.

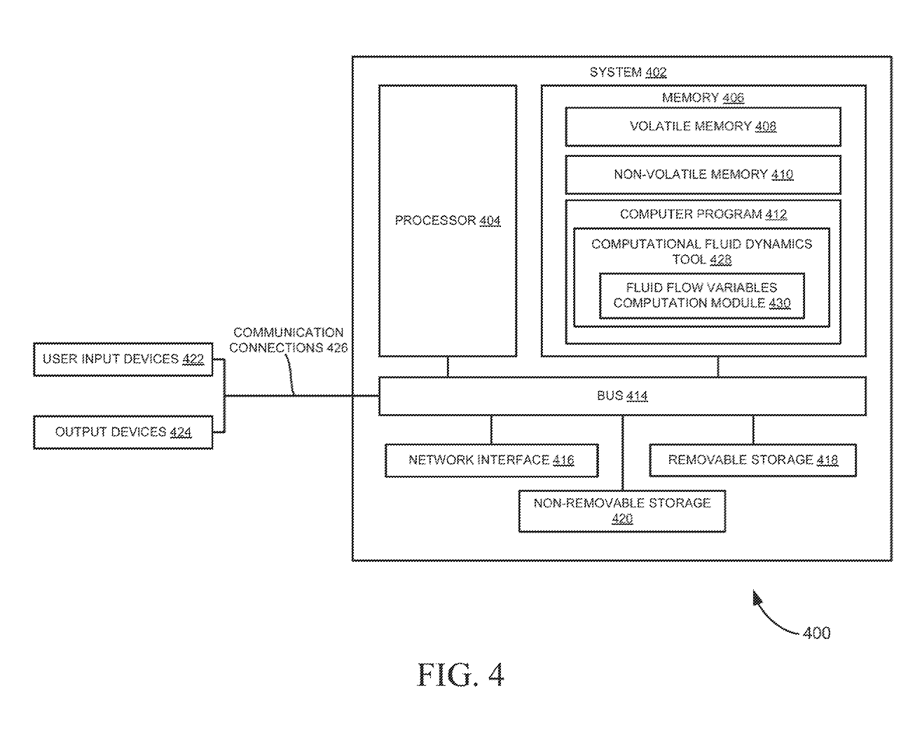

Referring now to FIG. 4, which illustrates an example system 402 including a computational fluid dynamics (CFD) tool 428. Further, the CFD tool 428 includes a fluid flow variables computation module 430 for computing fluid flow variables for three-way flow components in 1D fluid flow networks, using the processes described with reference to FIGS. 1-3. FIG. 4 and the following discussions are intended to provide a brief, general description of a suitable computing environment in which certain embodiments of the inventive concepts contained herein are implemented.

The system 402 includes a processor 404, memory 406, a removable storage 418, and a non-removable storage 420. The system 402 additionally includes a bus 614 and a network interface 616. As shown in FIG. 4, the system 402 includes access to the computing system environment 400 that includes one or more user input devices 422, one or more output devices 424, and one or more communication connections 426 such as a network interface card and/or a universal serial bus connection.

Exemplary user input devices 422 include a digitizer screen, a stylus, a trackball, a keyboard, a keypad, a mouse and the like. Exemplary output devices 424 include a display unit of the personal computer, a mobile device, and the like. Exemplary communication connections 426 include a local area network, a wide area network, and/or other network.

The memory 406 further includes volatile memory 408 and non-volatile memory 410. A variety of computer-readable storage media are stored in and accessed from the memory elements of the system 402, such as the volatile memory 408 and the non-volatile memory 410, the removable storage 418 and the non-removable storage 420. The memory elements include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 404, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 404 also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 404 of the system 402. For example, a computer program 412 includes machine-readable instructions capable of computing fluid flow variables for three-way flow components in 1D fluid flow networks in the system 402, according to the teachings and herein described embodiments of the present subject matter. In one embodiment, the computer program 412 is included on a compact disk-read only memory (CD-ROM) and loaded from the CD-ROM to a hard drive in the non-volatile memory 410. The machine-readable instructions cause the system 402 to encode according to the various embodiments of the present subject matter.

As shown, the computer program 412 includes the CFD tool 428. Further, the CFD tool 428 includes the fluid flow variables computation module 430. For example, the fluid flow variables computation module 428 can be in the form of instructions stored on a non-transitory computer-readable storage medium. The non-transitory computer-readable storage medium having the instructions that, when executed by the system 402, causes the system 402 to perform the one or more methods described in FIGS. 1 and 3.

Further, in some embodiments, some or all of the components of the fluid flow variables computation module 430 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like.

The systems and methods described herein enable fluid flow modeling of three-way flow components with undefined geometric properties in 1D fluid flow networks. Further, the systems and methods enable to incorporate design aspects, such as flow reversal for three-way flow components with defined and undefined geometric properties.

Although certain methods, systems, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for computing fluid flow variables for a three-way flow component in a one-dimensional (1D) fluid flow network, comprising:
determining a first flow configuration type of the three-way flow component using geometric properties and fluid flow characteristics of the three-way flow component;
computing a first flow ratio for the three-way flow component using the first flow configuration type;
obtaining fluid flow loss coefficients for the three-way flow component based on the geometric properties and the first flow ratio;
computing equivalent pipe loss coefficients for each pipe in the three-way flow component from normalization of the obtained fluid flow loss coefficients; and
numerically solving for the fluid flow variables using the obtained equivalent pipe loss coefficients, the geometric properties and the fluid flow characteristics of the three-way flow component.

2. The method of claim 1, wherein obtaining the fluid flow loss coefficients for the three-way flow component based on the geometric properties and the first flow ratio comprises:
determining whether the first flow ratio is an extreme flow ratio;
if so, performing flow reversal on a pipe with substantially no flow in the three-way flow component;
determining a second flow configuration type of the three-way flow component upon performing the flow reversal;
computing a second flow ratio for the three-way flow component using the second flow configuration type; and
obtaining the fluid flow loss coefficients for the three-way flow component based on the geometric properties and the second flow ratio.

3. The method of claim 2, further comprising:
if not, obtaining the fluid flow loss coefficients for the three-way flow component based on the geometric properties and the first flow ratio.

4. The method of claim 2, wherein computing the second flow ratio for the three-way flow component using the second flow configuration type comprises:
checking whether the second flow configuration type is substantially similar to the first flow configuration type;
if so, repeating the steps of performing the flow reversal, determining the second flow configuration type, and checking for a predetermined number of times; and
if not, computing the second flow ratio using the second flow configuration type.

5. The method of claim 4, wherein the fluid flow loss coefficients for the three-way flow component are computed using the first flow ratio after the flow reversal on the pipe is performed for the predetermined number of times.

6. The method of claim 1, wherein the geometric properties comprise a branch pipe diameter, a through pipe diameter, a branch angle, a through pipe cross-sectional area, a branch pipe cross-sectional area, and an area ratio, wherein the fluid flow characteristics comprise a fluid density, a mass flow rate and a fluid pressure, and wherein the fluid flow variables comprise variables selected from the group consisting of a fluid pressure, a temperature and a fluid velocity.

7. A system comprising:
a processor, and
memory coupled to the processor, wherein the memory includes:
a computational fluid dynamics (CFD) tool configured to:
determine a first flow configuration type of a three-way flow component using geometric properties and fluid flow characteristics of the three-way flow component;
compute a first flow ratio for the three-way flow component using the first flow configuration type;
obtain fluid flow loss coefficients for the three-way flow component based on the geometric properties and the first flow ratio;
compute equivalent pipe loss coefficients for each pipe in the three-way flow component from normalization of the obtained fluid flow loss coefficients; and
numerically solve for fluid flow variables using the obtained equivalent pipe loss coefficients, the geometric properties and the fluid flow characteristics of the three-way flow component.

8. The system of claim 7, wherein obtaining the fluid flow loss coefficients for the three-way flow component based on the geometric properties and the first flow ratio comprises:
determining whether the first flow ratio is an extreme flow ratio;
if so, performing flow reversal on a pipe with substantially no flow in the three-way flow component;
determining a second flow configuration type of the three-way flow component upon performing the flow reversal;
computing a second flow ratio for the three-way flow component using the second flow configuration type; and
obtaining the fluid flow loss coefficients for the three-way flow component based on the geometric properties and the second flow ratio.

9. The system of claim 8, further comprising:
if not, obtaining the fluid flow loss coefficients for the three-way flow component based on the geometric properties and the first flow ratio.

10. The system of claim 8, wherein computing the second flow ratio for the three-way flow component using the second flow configuration type comprises:
checking whether the second flow configuration type is substantially similar to the first flow configuration type;
if so, repeating the steps of performing the flow reversal, determining the second flow configuration type, and checking for a predetermined number of times; and
if not, computing the second flow ratio using the second flow configuration type.

11. The system of claim 10, wherein the fluid flow loss coefficients for the three-way flow component are computed using the first flow ratio after the flow reversal on the pipe is performed for the predetermined number of times.

12. The system of claim 7, wherein the geometric properties comprise a branch pipe diameter, a through pipe diameter, a branch angle, a through pipe cross-sectional area, a branch pipe cross-sectional area, and an area ratio, wherein the fluid flow characteristics comprise a fluid density, a mass flow rate and a fluid pressure, and wherein the fluid flow variables comprise variables selected from the group consisting of a fluid pressure, a temperature and a fluid velocity.

13. A non-transitory computer-readable storage medium including instructions executable by a computing device to:
determine a first flow configuration type of the three-way flow component using geometric properties and fluid flow characteristics of the three-way flow component;
compute a first flow ratio for the three-way flow component using the first flow configuration type;
obtain fluid flow loss coefficients for the three-way flow component based on the geometric properties and the first flow ratio;
compute equivalent pipe loss coefficients for each pipe in the three-way flow component from normalization of the obtained fluid flow loss coefficients; and
numerically solve for the fluid flow variables using the obtained equivalent pipe loss coefficients, the geometric properties and the fluid flow characteristics of the three-way flow component.

14. The non-transitory computer-readable storage medium of claim 13, wherein obtaining the fluid flow loss coefficients for the three-way flow component based on the geometric properties and the first flow ratio comprises:
determining whether the first flow ratio is an extreme flow ratio;
if so, performing flow reversal on a pipe with substantially no flow in the three-way flow component;
determining a second flow configuration type of the three-way flow component upon performing the flow reversal;
computing a second flow ratio for the three-way flow component using the second flow configuration type; and
obtaining the fluid flow loss coefficients for the three-way flow component based on the geometric properties and the second flow ratio.

15. The non-transitory computer-readable storage medium of claim 14, further comprising:
if not, obtaining the fluid flow loss coefficients for the three-way flow component based on the geometric properties and the first flow ratio.

16. The non-transitory computer-readable storage medium of claim 14, wherein computing the second flow ratio for the three-way flow component using the second flow configuration type comprises:
checking whether the second flow configuration type is substantially similar to the first flow configuration type;
if so, repeating the steps of performing the flow reversal, determining the second flow configuration type, and checking for a predetermined number of times; and
if not, computing the second flow ratio using the second flow configuration type.

17. The non-transitory computer-readable storage medium of claim 16, wherein the fluid flow loss coefficients for the three-way flow component are computed using the first flow ratio after the flow reversal on the pipe is performed for the predetermined number of times.

18. The non-transitory computer-readable storage medium of claim 13, wherein the geometric properties comprise a branch pipe diameter, a through pipe diameter, a branch angle, a through pipe cross-sectional area, a branch pipe cross-sectional area, and an area ratio, wherein the fluid flow characteristics comprise a fluid density, a mass flow rate and a fluid pressure, and wherein the fluid flow variables comprise variables selected from the group consisting of a fluid pressure, a temperature and a fluid velocity.
